(19) United States
(12) Patent Application Publication
(10) Pub. No.: US 2023/0011617 A1
(43) Pub. Date: Jan. 12, 2023

(54) Crowdsourced, Blockchain Computerized System and Method of Developing, Evaluating, and Funding Movies

(71) Applicant: Play Think LLC, GRANADA HILLS, CA (US)

(72) Inventor: Mikhael Bassilli, Granada Hills, CA (US)

(73) Assignee: Play Think LLC, GRANADA HILLS, CA (US)

(21) Appl. No.: 17/371,473

(22) Filed: Jul. 9, 2021

(51) Int. Cl. G06Q 20/40; G06Q 20/38

(52) U.S. Cl. CPC G06Q 20/401; G06Q 20/389

(57) ABSTRACT

A computerized system and method are disclosed for operating a crowdsourced and block-chained screenplay writing contest enabling writing submissions and financial transactions for each contest that are recorded on a blockchain account accessible by the contest participants to ensure they are paid fairly for their creative contributions. A screenplay writing contest is posted online; and a plurality of participants buy-in to a contest pool, sign a Smart Contract transferring ownership of their writing to the host, and upload their writing sample, which is timestamped and recorded on the system and/or the blockchain. Each writing submission is graded by at least one analyst, e.g. using an algorithm; and contest winners and contributors are selected. The buy-in pool is converted to blockchain tokens; and a portion of the revenue generated from selling the screenplay and movie tickets is paid into the pool; and distributed to contest participants in different earned amounts.

### FIELD OF THE INVENTION

The present invention relates generally to computer-implemented systems and methods covering the entire process of writing a screenplay to financing it and ensuring the creator(s) and screenwriter(s) receive the financial compensation promised. More specifically, it relates to computer implemented systems and methods using crowdsourced and block-chained technology for online competitions for writers to contribute their creative writings to an existing intellectual property (e.g., the original concept or plot idea), online hosts to acquire the rights to use those creative writings in the form of a final screenplay, determine the best version(s), and synthesize the best creative ideas into one screenplay for promotion within a crowdsourced voting mechanism that democratically funds productions and allows a plurality of investors to own and benefit from the success of a motion picture. The screenplay may be created by a collaboration of a plurality of writers, who use an online web portal that ensures they receive fair compensation for their creative contributions, from a block-chained certified pool of revenue, especially if it results in a commercially successful production.

### BACKGROUND OF THE INVENTION

Today, a screenplay will typically be written by a screenwriter at their own leisure. The screenplay—if lucky—will get optioned for little money (an “Option” is a contract that gives exclusive rights to a production company to shop the screenplay); and eventually purchased by a production company if the production company receives full production financing from a studio. For new screenwriters without an established reputation and agency representation, fair financial compensation is unobtainable. The vast majority of screenwriters in the world are working for free (aka “on spec”). If the writer manages to get their screenplay optioned or purchased by a production company, various loopholes exist that allow the production company to dilute the ownership and earnings of the writer/creator. The original screenwriter will usually be exploited, kept in the dark, and have zero transparency and compensation from sales and revenue earned from the movie.

However, with the onset of the internet, this writing and production process has become more decentralized to allow multiple users to each be one of the original co-screenplay writers on one project and/or to allow re-writes. For example, United States Patent Application US20140365860 A1 by Spielberg and Gustman, which published on Dec. 11, 2014, teaches a system that leverages internet communication for screenplay annotation development. U.S. Pat. No. 8,131,132 B2 granted to United Video Properties, Inc. on Mar. 6, 2012, discloses an online collaborative system for interactive content contributions. And, U.S. Pat. No. 8,341,525 B1 granted to Starsvu Corporation on Dec. 25, 2012, discloses an online collaborative process for script writers that is based on timeline mapping.

While these internet-based tools present reliable solutions for script and screenplay generation, what is needed in the entertainment industry is a decentralized system and transparent process that extends online collaboration through the concept creation and story editing stages and promotes transparency to the screenwriters of their earnings based upon their creative contribution and the film's revenue.

The present invention solves these problems and more, e.g.: 1) it makes the development of screenplays quicker; 2) it creates a better product through greater volume of creative input; 3) it creates transparency and equity for creators and screenwriters to ensure they receive the compensation they have contracted for; and 4) it offers a fully decentralized and democratic approach to the creation, development, and funding of media.

### SUMMARY OF THE INVENTION

Various embodiments of the present invention comprise a computerized system and method comprising a plurality of networked computers to run an online crowdsourced screenplay writing contest wherein writing submissions and financial transactions for each contest are recorded on a blockchain account accessible by the contest participants to ensure they are paid fees that they have earned. A screenplay writing contest (based on an existing intellectual property owned by the host) is posted online, and a plurality of participants buy-in to a contest pool via cryptocurrency tokens, sign a Smart Contract transferring ownership of their writing to the host, and upload their writing sample, which is timestamped and recorded on the system and the blockchain. A writing samples are evaluated, mined, and scored through algorithmic content scoring software unique to the present invention, and all writing samples are evaluated, mined, and graded across a plurality of screenwriting metrics from which the contest winners and script contributors are identified and announced. The best writings from all participants are aggregated into one final screenplay that is then voted upon via a social network of investors using a cryptocurrency token for the purpose of raising capital and democratically voting screenplays into production. The writer buy-in pool gains value based on the scale of investment and community activity, along with the sale of the funding of production, sale of the screenplay, and movie revenue paid into the pool upon sale and distribution.

The computer-implemented systems and methods primarily comprise: 1) crowdsourced, online competitions for the writing and/or re-writing of digital entertainment content, e.g.: screenplays for movies, documentaries, or live theater, TV scripts, short or commercial scripts, or any scripted content; 2) the use of blockchain technology for recording who are the original authors, and the financial rewards promised, earned, and distributed to each contest participant, contributor, creator and winner; and 3) an objective algorithmic scripted-content scoring method.

In an embodiment, a financial “Buy-in” or “Genesis pool” is created and recorded on a blockchain platform comprising the money deposited by each participant to be able to submit a draft of a screenplay based on the creator or host's intellectual property in a competition held on a website, or re-write an existing screenplay. If their submission is graded to be the best of the entire pool, then this participant becomes a contest winner. If a part of their submission (e.g. a character, plot twist, etc.) is used, they are declared a contributor. Creators, Winners and Contributors are allotted a greater share of the contest pool revenue. If the screenplay gets financed and distributed, then all participants in the writer pool see a gain in value of their existing cryptocurrency tokens. Each participant, contributor, contest winner, and original creator are distributed their liquid share in the pool from the blockchain automatedly when buy-out conditions are met, which they can check at any time to ensure they are being paid.

Various embodiments comprise a networked computerized system, method, and software for crowdsourced, blockchain screenplay writing contests, comprising:
a) a plurality of user computers for creating a screenplay writing contest, and for submitting in response to the contest, one or more of: a screenplay logline, outline, draft, and/or re-write for a plurality of screenplay contests;
b) a remote server comprising: a central processing unit; a memory; and a database storing a file for each of the plurality of screenplay contests;
c) a blockchain server for recording and tracking all transactions in a blockchain account associated with each screenplay contest;
d) an administrator computer for concurrently monitoring and controlling the screenplay contests, the remote server, and the blockchain server;
e) a network for linking (a-e);
f) wherein all transactions for each user in the plurality of screenplay contests is date and timestamped and securely stored on both the database file and the blockchain account; and
g) wherein a user computer comprises: a host computer for posting a screenplay writing contest; a plurality of participant computers for submitting a response to the contest; and at least one analyst computer for analyzing, mining, and scoring the screenplays.

The present invention further comprises software and application program interfaces (APIs) comprising one or more non-transitory computer readable storage media; a processor operatively coupled with the one or more non-transitory computer readable storage media; and program instructions stored on the one or more non-transitory computer readable storage media that, when executed by the processor, interfaces to carry out the methods herein.

In one embodiment, traditional financial accounts are used to pool the buy-in fees, screenplay and movie revenue, etc. In another embodiment, buy-in fees and revenue are converted to blockchain cryptocurrency tokens, which may be unique to the system.

An object of the present invention is a computer-implemented system and method to enhance the creative process of screenplay generation that is accessible to the general public. Screenwriters from around the world are afforded an opportunity to contribute writings to a single screenplay project, thereby enhancing the level of creative inputs and opportunities.

Another object is to leverage global information technologies to provide opportunities to creative writers who may not be privileged to have connections to the screenplay and movie industries. The website of the present invention will allow anyone with an internet connection to make writing submissions—even those writers without conventional academic or professional backgrounds are given an opportunity to submit their work.

Another object is to allow global input into the various stages of screenplay development. The web-based portal accepts writers who compete to work on loglines, outlines, various screenplay development stages, performing edits on the first draft stage, or during a rewrite stage.

Another object is to allow participating screenplay writers and editors to receive both monetary compensation and recognition through profit sharing and screen credits, respectively, when a work is eventually sold and distributed.

Another object is to allow individuals who may or may not be connected to the film and entertainment industry to manage and develop a screenplay production and benefit. In an embodiment, the web-based portal system of the present invention allows any user to assume control over managing the process of gathering, refining and promoting original screenplays. In addition, the web-based portal host receives monetary benefits from the screenwriters who participate, as well as from the sale, financing, or production of any screenplays themselves.

Another object is to automatedly grade the plurality of screenplay submissions in an expedited manner using an objective and unbiased algorithm of the present invention.

Another object is to allow a participant to be able to prove they were the original writer of a screenplay or a part thereof (i.e. contributing idea) using the timestamped blockchain and system records.

Another object is to enable all participants to check their accounts online to determine if they are being paid for their submissions, and when they can anticipate receiving payment.

Another objective is to enable the general public to invest in the success of the motion picture through a democratic voting and production funding system on the blockchain.

### BRIEF DESCRIPTION OF THE DRAWINGS

The accompanying drawings, which are incorporated herein and form a part of the specification, illustrate some, but not the only or exclusive, examples of embodiments and/or features.

FIG. 1 is a schematic diagram of an exemplary system architecture illustrating a network comprising: a plurality of screenwriter computers; at least one Host computer (if applicable); at least one analyst computer; a plurality of Investor computers, a website administrator computer; a remote computer/server for storing screenplay contests; and a blockchain server for recording and tracking financial rewards for each contest participant and investor.

FIG. 2 is a high-level flowchart of the method of creating and running a crowdsourced screenplay writing contest, promoting the screenplay, and then compensating writers while recording all financial transactions on a blockchain for earnings verification.

FIG. 3 is a flowchart of one participant and the system's steps when the participant enters multiple writing contests that are posted on the same website of the present invention.

FIG. 4A is Table 1 lists exemplary questions an analyst must use to evaluate each writing submission.

FIG. 4B is exemplary computer code for the computer system to determine a grade based on the analyst's input to the questions of Table 1.

FIG. 5 is a flowchart of user and system steps in the four exemplary phases of the invention, and demonstrating how two application program interfaces track each phase's results that are recorded on both the system database and the blockchain account.

FIG. 6 is an exemplary screenshot of a website application program interface for the administrator, which lists each participant's screenplay submission, name, and time stamps.

FIG. 7 is an exemplification of a contest from pooling the participants' entry fee, executing the smart contract with terms for percentages of earnings rewarded by user type.

FIG. 8 is a block diagram of an exemplary user's computer, e.g. a screenwriter's, host's, and administrator's computer.

Other aspects of the present invention shall be more readily understood when considered in conjunction with the accompanying drawings, and the following detailed description, neither of which should be considered limiting.

### DETAILED DESCRIPTION

It is briefly noted that upon a reading of this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

### Glossary of Terms

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

As used herein, the term “Project” is interchangeable with the term “Contest”; and, both refer to a screenplay that is intended to be financed, produced into a motion picture, and distributed.

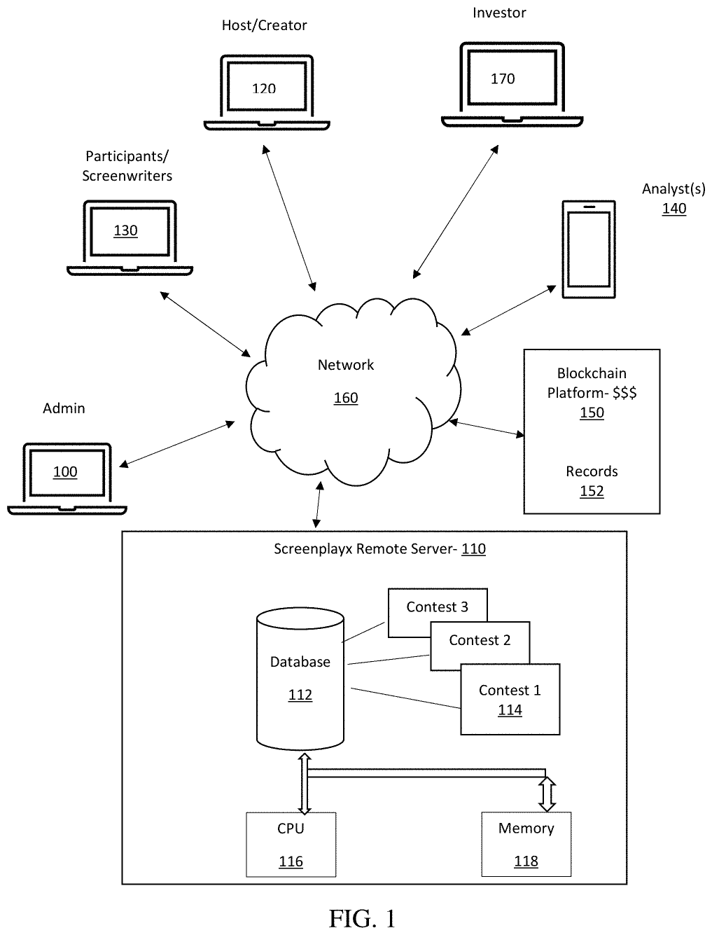

As used herein, the term “User” refers to any person who registers to have an account on the system website to participate in the writing, judging, and/or selling of a screenplay. A user inputs and receives data via their computer connected to the system network. Non-limiting example of system users are: administrator; contest host or creator; screenwriter or contest participant; analyst or contest grader; and project investor or producer. See FIG. 1.

As used herein, the term “Electronic Computing Device” refers to any electronic communications device comprising a central processing unit (i.e. processor) with the Internet connectivity, such as: laptops, desktops, tablets, iPads, smartphones, cell phones, personal digital assistant devices, and the like.

As used herein, the term “Software” and “Algorithm” refers to computer program instructions adapted for execution by a hardware element, such as a processor or CPU, wherein the instruction comprise commands that when executed cause the processor to perform a corresponding set of commands. The software may be written or coded using a programming language, and stored using any type of non-transitory computer-readable storage media or machine-readable media well known in the art. Examples of software in the present disclosure comprise any software components, programs, applications, computer programs, application programs, system programs, machine programs, and operating system software.

As used herein, the term “Module” refers to a portion of a computer program or software, such as a mobile app, and may further comprise the computer hardware that it is installed upon, and that carries out a specific function and may be used alone or combined with other modules of the same program. The module may comprise a native application, a web application, or a widget type application to carry out the methods of detecting and electronically transmitting untranslated character strings. In one embodiment, a native application is installed on the customer's, reviewer's and/or translator's electronic computing device, wherein it can be downloaded automatically from the Internet. It may be written in a language to run on a variety of different types of devices; or it may be written in a device specific computer programming language for a specific type of device. In another embodiment, a web application resides on the system server and is accessed via the Internet. It performs basically all the same tasks as a native application, usually by downloading part of the application to the device for local processing each time it is used. The web application software is written as Web pages in HTML and CSS or other language serving the same purpose, with the interactive parts in JavaScript or other compatible language. Or the application can comprise a widget as a packaged/downloadable/installable web application; making it more like a traditional application than a web application; but like a web application it uses HTML/CSS/JavaScript and access to the Internet.

As used herein, the term “Application Program Interface (API)” refers to a set of computer programming instructions, for accessing a web-based software application or web tool. In an embodiment of the present invention, there are at least two API's: 1) one for transmitting data from the system database to the blockchain; and 2) one for transmitting data from the blockchain to the system database and processor. In another embodiment, one API performs all functions (1-2), e.g. concurrently.

As used herein, the term “A System” may be used to claim all, or parts of, the aspects of the present disclosure wherein it refers to the entire configuration, or parts of, the networked computerized system, e.g. all hardware and software used in all scenarios. Preferred embodiments are illustrated in the system architectures of FIG. 1.

As used herein, the terms “Processing,” “Computing,” “Calculating,” “Determining,” “Establishing”, “Analyzing”, “Checking”, or the like, may refer to operation(s) and/or process(es) of a computer, a computing platform, a computing system, a computer central processing unit (CPU), or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

As used herein, the term “Crowdsourcing” refers to using a plurality of registered system users who enter a system writing contest, wherein the users each submit one or more of: screenplay loglines (i.e. a one sentence summary), outlines, first drafts, re-writes, etc. until a winning screenplay is selected by the host or creator.

As used herein, the term “Blockchain” refers to a Decentralized Ledger Technology that makes the history of any project, including but not limited to user name, contest name, or digital asset. All data regarding all projects/contests on the blockchain is unalterable and transparent.

As used herein, the term “Token” refers to the cryptocurrency linked to the blockchain. In an embodiment, the system will generate a unique system token, such as through Cardano™, Etherium™, and Binance™. A user's tokens are deposited to their system wallet; and can be cashed-out when the pool matures (e.g. passage of time deadline), and cash-out conditions are met.

In an embodiment, the system creates a unique token with name of “SPX” on Binance™. This unique token functions like a unit of currency that gives each contest user access to certain features given by the API “screenplayerx.com”. After a successful initial coin offering (ICO), the system will integrate the API to get the current rate from trading and the same currency rate will be used for all transactions on screenplayerx.com. As used herein, the term “Smart Contract” refers to a digital contract executed by the participant as a condition for submitting their writing sample into a system screenplay writing contest. It comprises the terms of the agreement between the user and the host being directly written into lines of computer code; then the code and the contract a stored and accessible across the system's distributed, decentralized blockchain network. The code controls the execution, and the transactions are trackable and irreversible. In an embodiment, the system will check whether the user is an authorized system user before recording the smart contract on the network.

In an embodiment, the Smart Contract comprises the terms of:
a) a buy-in fee for the user to participate in each screenplay contest;
b) an amount or percentage of revenue the user will earn if the user's screenplay wins the contest or is considered to contribute;
c) an amount or percentage of revenue the user will earn if the production of the screenplay is financed;
d) an amount or percentage of revenue the user will earn if a movie generates gross earnings;
e) one or more conditions for when a user may cash-out their earnings; and
f) a guarantee a winning and/or contributing screenplay writer will receive movie screen credits.

Cryptocurrency and Wallets: Various embodiments of the present invention rely on the use of tokens to buy-in to a contest and to pay the winners, contributors, and creators, especially when a screenplay is financed, produced, and later generates revenue from a movie release. ERC-20™ is one type of cryptocurrency used with the blockchain platform of the present invention. It is similar, in some respects, to Bitcoin™, Litecoin™, and any other cryptocurrency. ERC-20 tokens are blockchain-based assets that have value and can be sent and received. The primary difference is that instead of running on their own blockchain, ERC-20 tokens are issued on the Ethereum™ network. In an embodiment, the blockchain platform of the present invention uses a combination of cryptocurrency, such as Binance™ and Cardano™

Screenplay Ownership: In an embodiment, the host owns the website that the contests are posted on; but, does not own the original or final screenplay, or any of the participants' submissions. This is owned by the creator of the content in accordance with website Smart Contract terms. In another embodiment, the host acquires ownership of the creator's original submission (outline, draft screenplay), and any other participants' submissions, including the winning screenplay for a fair compensation or consideration, which is also recorded on the blockchain using a Smart Contract.

As used herein, the term “Contest Pool” and “Genesis Pool” refers to the total amount of currency (system unique tokens) within a contest account, and includes: the buy-in paid by each participant in a contest; and may further include any revenue owed to the system by the selling the winning screenplay or movie (e.g. 45%); and a producer's share of their backend net profits (e.g. 5%), if applicable. The blockchain and contest file dates, timestamps, and records each transaction of each user.

Fees and Compensation: as disclosed herein, each user of the website may be required to pay a one-time fee (i.e. a buy-in) to participate in a writing contest. They may pay with fiat currency (e.g. PayPal™), or with cryptocurrency (e.g. from Ethereum™ and Binance™). This revenue is added to the “Contest Pool” or “Genesis Pool”, and revenue from the production financing, sale of the script, and from a movie release are then distributed to the users at a set time (e.g. 2 years) in accordance with the terms of the Smart Contract executed before submitting their writing. The amount each user is awarded is also a function of their user type or class (e.g. creator, participant, contributor, winner, investor); and may be based on a percentage of the Contest/Genesis Pool.

Marketing of Winning Screenplay/Script: Upon the satisfactory completion of the Screenplay, the script will then be hosted on a Screenplay Initial Coin Offering (ICO) or data management platform where the host and/or the creator will then begin to market the screenplay amongst a broad scope of consumers, industry professionals, including major agencies, studios, producers, directors, and investors. There are three scenarios in which the User increases their revenue from this point forward:
1) When a limited amount of tokens are made available on a Screenplay ICO and a tokenized investment is procured from a plurality of investors who invest tokens into the development and production on the screenplay, thus building demand and value behind the realization of the screenplay.
2) When the screenplay sells, the revenue will be either received straight to the blockchain, or received through a bank and manually recorded on the blockchain, at which point Users with an equity Percentage of Screenplay Ownership will see their revenue increase on the blockchain; and/or
3) When the movie is distributed and revenue is earned, the revenue will be either received straight to the blockchain, or received through a bank and manually recorded on the blockchain, at which point Users will see their revenue increase on the blockchain.

Cashing-Out: In an embodiment, the Contest Pool or “Genesis Wallet” is maintained for a set period of years (e.g. 2 years) or until a set amount of increase over the original pool is reached (i.e. the Capped Revenue, such as 200%-500% return on original contest pool). When either of these conditions is meet, then tokens will automatically transfer to a user's wallet and they will be able to cash-out (e.g. convert unique system tokens to fiat currency that can be converted to cash or deposited in the bank).

### Detailed System & Method

As explained above, the present invention is a computer-implemented method and system comprising: a software, such as a mobile application (non-transitory computer readable storage medium) and/or web-based portal (e.g. website) for accepting from one or more screenwriters a movie logline, outline, and/or script, acquiring the ownership rights to the script by a contest host, if required; developing the script through re-writes from the same or other screenwriters, analyzing the winning screenplay through a content scoring algorithm, compiling the best ideas into one screenplay, promoting the screenplay on a Screenplay ICO for crowdsourced voting and funding, and promoting the selling of the winning screenplay to a distributor. Writers from around the world enter competitive contests using the web-based portal operated and managed by the administrator. The website host, or the contest creator, or an independent third party, will judge the uploaded screenplays, select winners and contributors, develop the material through subsequent contests as needed, and promote the finished screenplays to movie and entertainment industries for a profit. The blockchain platform will record and distribute all financial awards due to the users, which they may track at any time (e.g. whether or not the movie script sold and for how much).

FIG. 1 is a block diagram of an exemplary networked computer system of the present invention comprising:
1) an “admin” or administrator computer 100 that advertises and supervises one or more online writing contests, e.g. screenplays or movie script competitions;
2) a competition host or creator computer 120 for uploading the original idea or draft that is the starting point for the writing competition;
3) a plurality of screenwriter computers 130 for submitting their writing to a selected contest;
4) at least one analyst computer 140 per contest to initially judge the writing submissions;
5) a blockchain platform 150 for tracking and recording all financial transaction associated with a contest through to a film's revenue, or the like; and
6) a wireless network 160 (e.g. the Internet) that connects all of the system computers.

In an embodiment, the system further comprises one or more investor or film studio computers 170 that the admin computer 100 electronically transmits a winning screenplay to in an attempt to attract investment.

In an embodiment, the admin computer 100 is an electronic computing device (e.g. laptop, desktop, tablet, etc.) that is connected to a cloud or remote server 110 (e.g. Amazon™ cloud computing service), which comprises: a central processing unit 116, a memory 118, and a database 112 storing a plurality of digital files, e.g. one file per each contest or project 114, wherein a plurality of timestamped writing submissions and financial blockchain transaction are stored in each project 114 by participant. The system allows each participant to log into their account, and determine how much financial equity they have earned for each contest they participated in.

In an embodiment, there may be more than one creator computers 120 linked to the same remote server 110, such that a plurality of competition are concurrently running on the same website.

As used herein, the term “Admin” refers to the website owner or administrator.

A “Host(s)” and “Creator(s)” refers to the entity posting a writing contest on the website or platform of the present invention. In an embodiment, the creator is the individual or organization that owns the intellectual property on which the contest is based (e.g. a general idea for a film plot); and the host is the owner of the system website posting all of the writing contests. In another embodiment, the creator is a registered user of the system website who wants other registered users to submit writing samples for their posted project; and there are multiple creators on the website (e.g. production companies). In another embodiment, the host desires to become the owner of the authored material submitted by the screenwriters in consideration for giving them and the creator a financial equity in the project. In most circumstances, the host is the final authority as to the results of the contest (e.g. deciding winners, contributors, etc.). At times, herein, host and creator are the same entity.

A “Participant” or “Screenwriter” is a system user who pays the website-host to submit an entry to the writing contest; and their writing submission is timestamped and stored on the remote server database. In an embodiment, their payment is a “buy-in” to a contest pool.

A “Contributor” refers to a user who was a participant, and some aspect of their writing submission was selected for use in the winning screenplay, e.g. a character, a plot twist, etc. The contributor earns a share of the screenplay earnings; a share of the contest pool; and potentially a small share of the producer's net earnings.

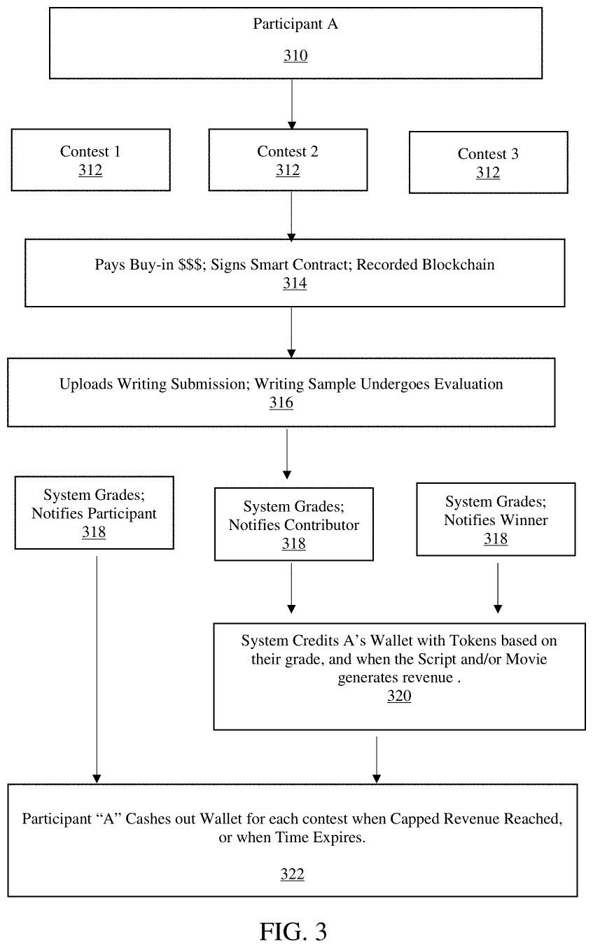

A “Winner” is a participant whose writing submission was selected, e.g. by the host, as the one to market, and it may include edits by other participants and/or the host. The winner earns a percentage of the earnings from selling the screenplay; a share of the contest pool; and possibly a percent of the producer's net backend earnings. In an embodiment, the total earnings are equal for the creator of the original idea and draft, and the winner of the re-write, (e.g. see FIG. 3).

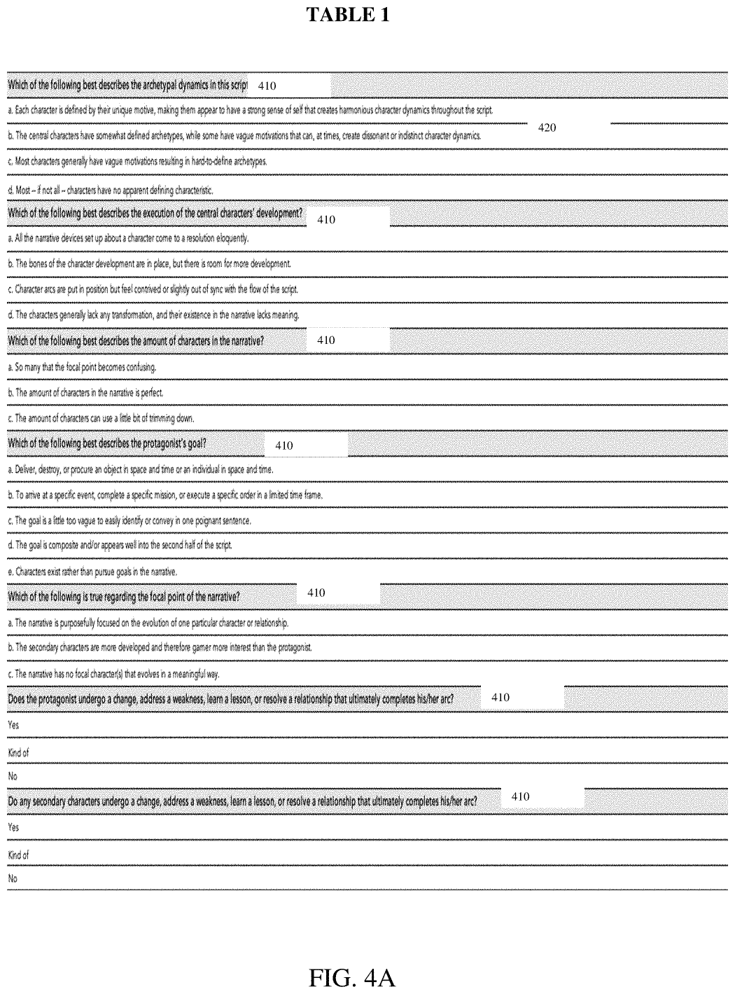

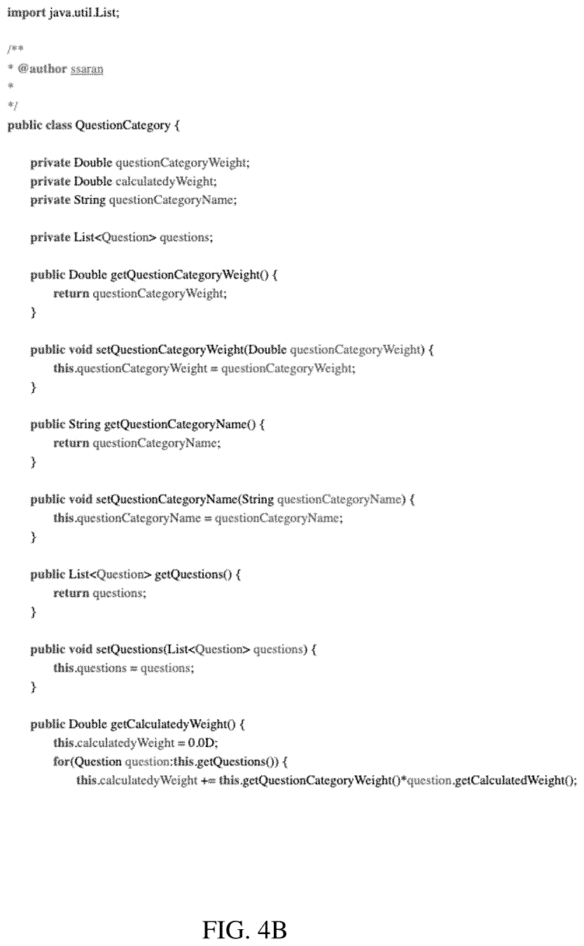

An “Analyst” or “Reviewer” is a user who objectively evaluates the plurality of writing submissions in a system contest; and mines for the best writers, ideas, plot twists, characters, etc. They input into the system their answer displayed from the algorithmic questions of the present invention for the purpose of quantifying the best screenplays and ideas for the screenplay. In an embodiment, the Analyst is merely answering objective questions regarding the mechanics of the screenplay, which they enter an algorithm of the present invention. In another embodiment, the Analyst(s) mine the writing submissions for features to add to the winning screenplay. See FIGS. 4A and 4B for an exemplary questionnaire and algorithm.

An “Investor” is a system user looking for a great script. In an embodiment, an investor is a contest host, and a percentage of the revenue s/he earns from selling the screenplay and/or from movie royalties is add to the Contest/Genesis Pool in accordance with a Smart Contract they have signed. In another embodiment, the investor has access to all screenplays on the network that have completed a contest cycle. In another embodiment, the investor is any individual in the network who invests in the project through a Screenplay ICO. Investors may participate in the website for free, or they may be required to pay, especially if they are using the website to search for talented writers and projects they would like to sponsor and promote.

Method Flowchart

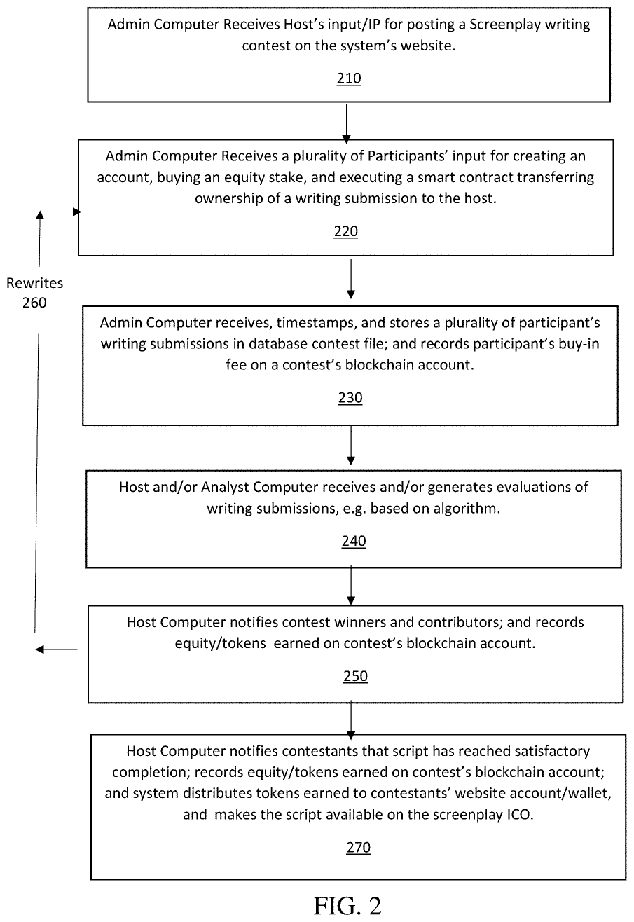

FIG. 2 is a flowchart of general system computer steps used with the networked computer system of FIG. 1 in carrying out a crowdsourced, block-chained screenwriting contest of the present invention.

In step 210, the central computer-server 110 will receive input via a network 120 from a host or creator computer 120 with the criteria for a new writing contest. Non-limiting examples of criteria, or writing submissions “requirements”, that the creator uploads or inputs comprise, e.g: a) a logline with the requirements for an outline; b) a script outline with requirements to generate a screenplay's first draft; and c) a screenplay first draft with requirements for a rewrite. In an embodiment, the creator is required to first create an account on the system, and may be further required to pay a one-time equity stake fee (aka a “buy-in”). In another embodiment, there is only one system host, who thus owns the website, and who may post all of the writing competitions (e.g. a production company). The host then becomes the owner of all the screenplay submissions in consideration at least for giving each participant writer an equity in the project for which they have uploaded a screenplay. Thus, the host computer 120 is equivalent to the admin computer in FIG. 1. Furthermore, in step 210, the central computer-remote server 110 will receive input from a host's computer 120 (directly via the internet or through the admin computer 100) to post specific details about a writing competition on the website of the present invention. Input comprises, e.g.: Contest Dates; Requirements (i.e. write a first draft based on an Outline); and Smart Contract terms (i.e. winner's percentage of screenplay ownership, contributor's percentage of screenplay ownership, etc.). The creator's input is timestamped and stored in the contest's project file 114 on the database 112 on the central server 110.

In step 220, the admin computer 100 or server 110 will receive input via network 160 from one or more (a plurality of) screenwriters' computers 130 to register an account with the system, buy an equity stake in the contest, and execute a digital contract that transfers ownership of their writing submissions to the host. In an embodiment, each screenwriter participant will pay a fee to register an account; and to submit their work to a specific posted contest. This fee (e.g. $100) per contest is to stake their equity and creative contribution into a specific contest—e.g. buy into a pool. Each screenwriter's equity payment and the identity of the payer is timestamped and recorded on the blockchain platform 150 under the record for a specific contest 152; while the registration information, writing submissions, and earnings are timestamped and stored on the database contest file 114 on the central server 110.

The server 110 timestamps and stores the information for each participant screenwriter comprising, but not limited to: a screenwriter's name, address, telephone, email address, professional background, etc. as well as payment information for participation in a contest (through online payment methods that include but are not limited to PayPal™, Stripe™, Venmo™, direct deposit, other cryptocurrencies, etc.).

In step 220, and before uploading their screenplay, the admin computer 100, or server 110, will transmit and display on each screenwriter's computer graphical user interface (GUI) a digital Smart Contract with terms for the host receiving and accepting a screenwriter's online submission to a specific contest/project. Exemplary contractual terms comprise, by way of non-limiting examples: that the screenwriter becomes a share equity holder of a predetermined percentage pool; that additional compensation is awarded to the screenwriter if their submission is voted as the contest winner; that winner will receive screen credits; etc. The screenwriter may be rewarded for winning the entire competition, or for use of some aspect or feature of their submission (e.g. character, plot twist, etc.). Specific terms of compensation for using one or more features in a screenplay are listed within the contractual agreement. The contract requires the screenwriter's digital signature to allow the host to secure the rights to the screenplay (in accordance with the agreement document drawn up and presented on the website) upon which the signed contract is then saved into the contest file 114. The winning screenwriter then receives screen credits and a financial reimbursement according to the website portal host predetermined amount.

In another embodiment, based on the website terms of use, upon uploading their writing submission, then the screenwriter has effectively accepted the terms of the contract, and is not required to execute a digital contract.

In step 230, the admin computer 100, or the server 110, receives the plurality of screenwriters' contest submissions. When the screenwriter uploads a copy of their screenplay to the central server in one or more designated file types (e.g. Word document, Final Draft, PDF, etc.), it is timestamped with the date and time of submission, that is recorded on the database 114 along with a copy of the writing. In an embodiment, a digital link is automatically created between the writing submission database record 114 and the participant's blockchain equity buy-in record 152 on blockchain platform 150. With this, a participant can trace the exact date and time of their writing submission, equity paid and earned for it, and retrieve a copy of it.

In step 240, the admin computer 100 or the analyst computer 140 then retrieves the screenplays from the database record 114 for the analyst(s) to evaluate. The analyst is one or more of: the contest creator or host, or an independent third party (e.g. a professional writer, director, movie executive, system employee, etc.). The reviewer does not select the winner, the host will select the winner. The analyst is an objective evaluator of the screenplay; and s/he must input their answer to specific algorithmic questions regarding the mechanics of the screenplay, e.g. selecting from a series of multiple choice survey questions, written answers, and/or by assigning a numerical value to each question. The questions are part of a weighted scale algorithm that objectively scores the screenplay across numerous datapoints. Through this scoring mechanism, certain scripts will rank higher than others, and it's the job of the host to make that final determination as to which screenplay is the best and which ideas should comprise the final screenplay.

After the analyst(s) complete the evaluations for all participating scripts, the host computer 120 is electronically notified (if the host is not the analyst) of the algorithmic conclusions, and the host then approves the winning screenwriter(s), and/or makes their own adjustments. The system then notifies the winners and contributors via at least an electronic communication (e.g. email, text, chat, etc.), and issue a tokenized reward on the blockchain in the form of additional cryptocurrency from what was given for being a contest participant (step 250).

In another embodiment, there may be more than one winner, as different features of various screenplays are selected for the final winning work. For example, the reviewer may decide to add a character from one screenplay, while using the main plot from another screenplay. Compensation may be determined on the amount or feature of each screenplay submission that makes it into the final winning version.

In an additional embodiment, if the host determines that the most favorable screenplay still requires a re-write, e.g. such as the criteria of step 270 are not met, then steps 220-250 are repeated (see loop 260). The same screenwriters and new screenwriters are able to submit their amendments to the existing screenplay for an equity stake that is recorded on the blockchain 150. It is also noted that the original step 210 may comprise a contest for a screenplay previously acquired or written by the host that requires re-writing.

In an exemplary embodiment of the loop of steps 220-260, the first round of writing comprises awarding the winning outline, the second round of the same contest comprises awarding the winning first draft, and the third round of the same contest comprises awarding the final screenplay.

In step 270, if the final screenplay is completed satisfactorily, then no other contests (re-writes) are required, and the admin computer 100 or the host computer 120 then electronically transmits and promotes the winning screenplay to the Screenplay ICO where producers, investors, fans, and audiences can vote to fund the production by investing their tokens towards the screenplay. Promotional activities further comprise those well known in the entertainment industry, e.g.: conference calls; face-to-face sales pitch; press releases; etc.

Furthermore in step 270, the admin computer 100 electronically transmits to all contest participants, winners, and contributor computers 130 with an equity stake, notification of the fact the script has entered the Screenplay ICO, the amount of capital the project has raised, the terms of any deals that have been made (i.e. actor, director, producer buy-ins or involvement etc.); or the fact that the script has not scored high enough to be displayed on the Screenplay ICO. When a threshold of capital is raised (i.e. 200% of the total contest pool), then the admin computer 100 or the blockchain platform 150 electronically makes the contest pool liquid and distributes the profits to the participants, contributors, creators, and winners crypto wallets, along with ensuring that the screenwriter receives screen credits on any film produced. In an additional embodiment, once a movie is produced, distributed, and revenue is generated, it is recorded on the database file 114, the blockchain account 152, and transmitted as tokens to the winners' and contributors' system accounts.

In an embodiment, the contract between the contest host and each screenwriter equity stake holder is memorialized using timestamps well known in the art. The process comprises timestamping upon submission to the central computer (FIG. 1,110): 1) a digital signature of each screenplay writer for their equity contract; 2) each participant's submission to determine novelty (e.g. which writer was the first to submit a unique creative idea to the system); 3) the electronic notification sent to the winning writer(s) with the terms of their award; and 4) a final project contract outlining, summarizing the identity of each stakeholder and their equity amount earned, as well as any other competition agreed to. One or more of these processes can also be encrypted to prevent hacking.

Each of processes (1)-(4) is stored in their project file 114 on the central database 112.

In another embodiment, the financial transaction associated with one or more of processes (1)-(4) can be stored using blockchain technology. For example, in process (4) involving the contract for all users who are sharing an equity in a project, the contract and all its amendments with specific monetary amounts, and percent earnings, are stored using a distributed ledger technology, or blockchain, wherein each block contains a cryptographic hash of the previous block, a timestamp, and transaction data (generally represented as a Merkle tree). The participants' computers in a contest project may be part of the peer-to-peer computer network of the blockchain. Thus, each contest user is able to view the current equity of the other contest users, and when a sale of the screenplay occurs, as well as the terms of the sale.

### Multiple Concurrent Contests

FIG. 3 is a flowchart of a Participant “A” entering three different contests concurrently on the system (step 312). For each contest (1-3), the participant will pay a buy-in fee, and digitally sign a Smart Contract, which details the compensation they will receive long-term, transfer of ownership of the participant's writing submission to the host, and other system user terms. The Smart Contract and buy-in fee amount are dated and timestamped, and recorded on the blockchain account and contest file (FIG. 1, 114), and the fees are converted to tokens if paid with fiat currency. The fees are then credited to the “Genesis Pool” on the system database (step 314).

In step 316, Participant A uploads a writing submission. One or more analyst(s) then performs an evaluation of the writing submission, using an algorithm of the present invention for all participants in a contest, and the host 120 or admin 100 notifies Participant A if their submission is selected. For example, in Contest 1, they were not selected; in Contest 2, then were awarded “contributor” status; and in Contest 3, they were awarded “Winner” status (step 318). The notifications and contracted for percentage of Genesis Pool earnings based on their status is dated and timestamped, and recorded on the blockchain file 152 and the contest file 114.

In step 320, if the screenplay is funded and/or if a movie is distributed that generates revenue over production costs, then the percentage of the host's net earnings due to the system under a Smart Contract that was executed by the owner of the screenplay (e.g. host, creator, investor, producer, etc.) are deposited into the “Genesis Pool”. Its date and amount are timestamped and recorded on the blockchain account and the contest record 114.

In step 322, pool cash-out conditions have been met for at least one of the three contests because either the Smart Contract's maximum time for holding the funds in the Genesis Pool has expired; or the maximum monetary amount allowed in the pool has been reached. This maximum amount may be a percentage of the original Genesis Pool (e.g. 200-500%), or it may be a set amount. The blockchain will automatically notify the system to release tokens to Participant A's wallet for contest 1, 2, or 3; who may then convert them to cash or transfer them to their bank.

### Grading Screenplays

As previously disclosed supra for grading: at least one independent analyst grades the writing submissions. The results are then made visible to the host, who then determines whether a participant should be upgraded to a contributor or a winner to be awarded a tokenized bonus equity stake in the contest. Grading may be subjective, objective based on an algorithm—such as in FIG. 4 of the present invention, or a combination thereof.

In another embodiment, the host, creator and/or the analyst(s) subjectively evaluates the screenplay, logs the scores of each screenplay into the database 114, which is visible for viewing on the host computer 120, at which point the host determines the winning screenplay based upon their professional opinion of the quality, novelty, and marketability of the final screenplays.

In another embodiment, the host, creator, and/or an independent third party determines the winning screenplay using an objective scoring system. For example, each of the criteria from step 240 is given a weighted value, and the screenplay with the highest total score from summing these values is declared the winner.

In yet another embodiment, both a subjective overall score and an objective score may be used to declare the contest winner.

In yet another embodiment, a crowdsourced or social media platform is used to electronically receive and sum votes from a plurality of graders, such as website members of the present invention who are not submitting screenplays in the contest being voted on.

In yet another embodiment, there may be multiple grading sessions. For example, grading may first be applied to each creator's request to open a contest. If the host determines that a contest should be created, then the project is approved, timestamped and recorded on the database file 114, and the blockchain file 152. The grading is repeated with each round of submissions (e.g., step 240 in the first round of drafts; and again, if re-writes are required in step 250).

In yet another embodiment, there may be an automated grading for the entire process (e.g., 210-240). For example, grading may first be applied to each creator's request to open a contest. If the grade is above a threshold, a contest is automatedly created, timestamped, and recorded on the database file 114, and the blockchain file 152. The grading is repeated with each round of submissions (e.g., step 240 in the first round of drafts; and again, if re-writes are required in step 250).

FIG. 4A is an example of a method of objectively grading a writing submission. The analyst(s) is required to answer a series of questions 410 online about each participant's writing submission by selecting one of the multiple-choice responses 420. A computer algorithm of the present invention will compute the sum total value of the questionnaire, and determine if the submission is of the content, quality, and marketability sought by the creator (e.g. meets a minimum sum total value). Exemplary questions the analyst must respond to are in Table 1 of FIG. 4A.

FIG. 4B is exemplary computer code for the computer system to determine a grade based on the analyst's input to the questions of Table 1. In this exemplary embodiment, each question of Table 1 is given a weighted value, and the sum total value of the questions is computed. Those questions are assigned values (1-10) and questions are set on a weighted-scale algorithm that ensures accuracy of the script's overall score.

The algorithm provides a score across multiple broad categories” (e.g. character, plot, dialogue, format, etc.) and also provides a score across multiple sub categories (e.g. the broad category of “Character” can consist of sub categories, including but not limited to: “dynamics,” “arcs,” “motives,” “objectives,” “stakes,” etc.). These subcategories are assigned value (1-10) and comprise of the total weight of the broad category. In an embodiment, the algorithm is used to automatedly grade drafts and re-writes of full screenplays; and in another embodiment, it also is used to grade all types of writing submissions: a screenplay logline, a screenplay outline, a complete screenplay draft, and/or a re-write of a complete screenplay.

### API's and Blockchain:

In an embodiment, the computerized system uses at least one Application Program Interfaces (API's) of the present invention: to electronically transmit data between the system database 112 and the blockchain platform 150 (e.g. see FIG. 1) for each writing contest. There is thus at least one electronic file 152 on the blockchain platform for each contest.

By way of non-limiting examples, the API will transmit data from the database 112 to the blockchain account 152 via the network 160: when a contest is created; a copy of the smart contract is signed; and when an award of a winner or contributor in a specific contest is made to record promised earnings for when the script and/or movie sells. In an additional embodiment, a timestamp as proof of each participant's writing submission is recorded on the blockchain record 152. A digital image, or an actual copy of the writing submission may be recorded.

And the same or a different API will transmit data from the blockchain account 152 to the database 112 to store in a participant's record in the file 114. Data primarily comprises equity and earnings due to the participant for a specific contest, and the total revenue and current status of a winning screenplay from the contest. This enables a participant to log into their system account file 114 and view any revenue they have earned, or might earn in the future.

The API's of the present invention and the blockchain account, or non-transitory computer readable storage medium, requires a unique identifier to be assigned to each system user, comprising for example, one or more of: email address, crypto wallet account, computer generated identification number, etc. The blockchain can be accessed via a blockchain website that a user logs into with their unique identifier to view all records in a contest file to verify that are receiving the earnings they contracted for; and their crypto wallet.

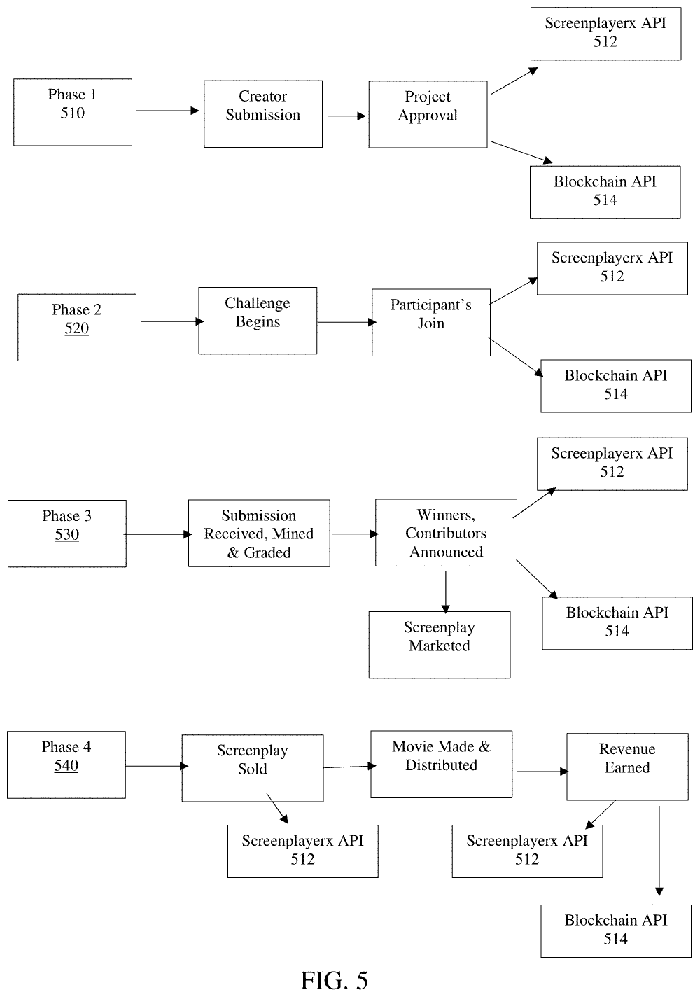

As illustrated in FIG. 5, in another or additional embodiment, two different API's 512, 514 of the present invention concurrently transmit data to the database 112 and the blockchain file 152 when a contest milestone is reached, e.g.: a creator's request for the system to post a contest is approved 510; when each participant executes a smart contract and uploads their writing submission 520; when a challenge results in declaring a winner and contributor(s) 530; when the screenplay is sold, and revenue is made from movie ticket sales 540.

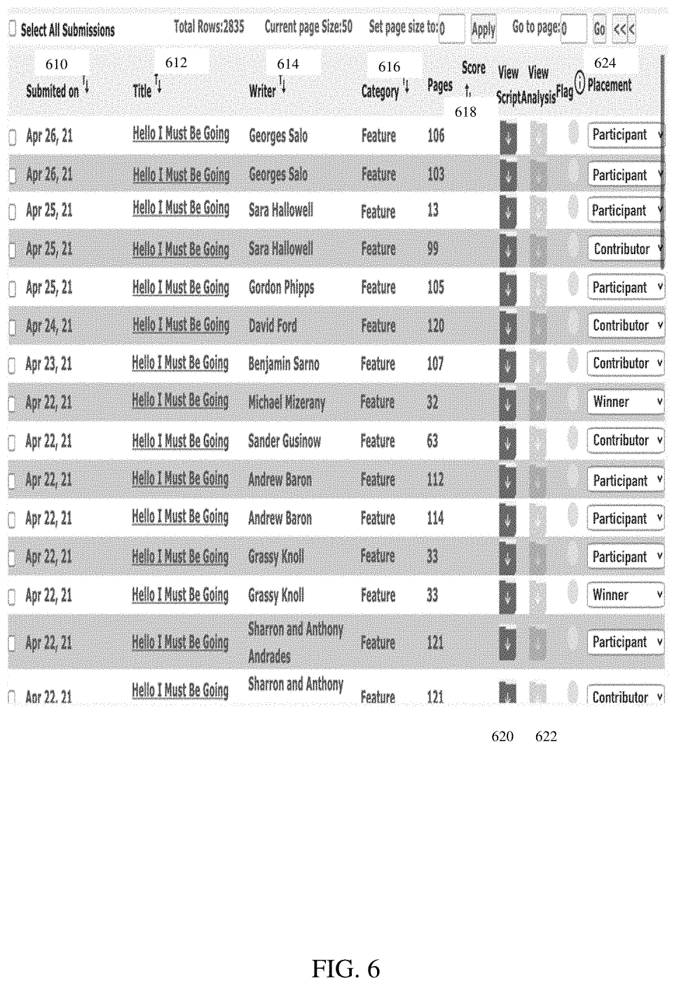

FIG. 6 is an illustration of a website software of the present invention (non-transitory computer readable storage medium) that an administrator can access to view the status of each contest. By clicking on a webpage link, they are directed to the blockchain record 152. They can view the status of any contest they entered, e.g.: script sold for specific amount; how much participant earned from sale; movie revenue; how much participant earned from revenue, etc. In another embodiment, they can view all of the files recorded for a contest (e.g. what each winner and contributor earned). In the exemplary embodiment of FIG. 6, the administrator can view: date of submission of each writing sample 610; title of contest 612; participant's name 614; type of movie 616 (e.g. feature film, documentary, etc.); page length of submission 618; a copy of the submission 620; the grading analysis 622; and the winners, contributors, and participants announced at the end of the contest 624.

Additionally, the user can log into their account on the system database to view their dashboard, which displays, for example: all of the contests they have entered, copies of smart contracts and their writing submissions with time stamps, and earnings due.

### Proof of Winning Script & Pool Earnings

A participant can use the computerized system of the present invention to verify they are the original writer and retrieving a date and timestamped copy of their writing submission; and to verify the total earnings due to them by using their accounts on the system database and their blockchain account.

A participant can prove they were the first user to upload the winning screenplay, or a specific aspect of it (i.e. to make them a “contributor”) by comparing the time stamp of their submission versus a competitor's on the system database 112; and/or by retrieving a copy of their writing submission with time stamp from the blockchain record. This may become important in disputes over ownership and rights to script and movie revenue. And with the Application Program Interfaces (API' s) of the present invention, this is extremely easy and time efficient.

For example, if Script X sells on a specific date for a set price, which is recorded on the blockchain, then a participant can look up the sale at any time via the contest's blockchain account; and trace it back to the electronic record linked to their writing submission, which is stored with a timestamp in the contest file 114 on the database 112 of the host's remote server (see FIG. 1, 110).

Hence, contest participants are assured that their rights to revenue generated by their contributions to a screenplay are protected by the system because: 1) their earnings are automatically credited to their account on the server 110 by the blockchain platform 150; 2) the blockchain platform prevents any entity from manipulating which writers contributed what ideas and when, and how much their contract guaranteed them; and 3) the writer can track the contest earnings, and their entitled earnings at any time to ensure they are correct and that the system is paying them (in cryptocurrency).

### Exemplification

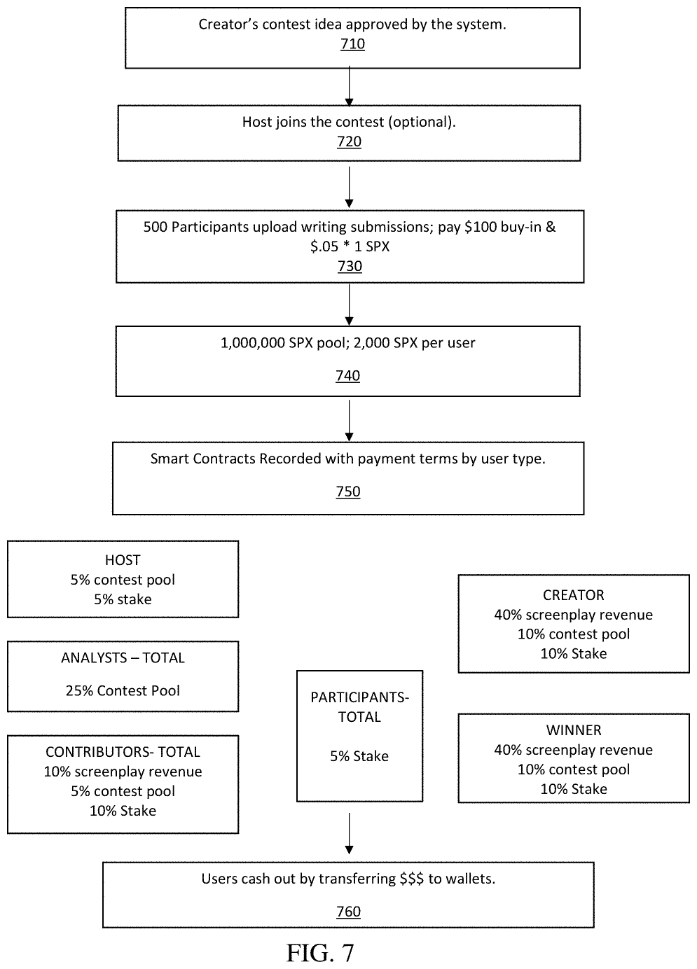

FIG. 7 is an exemplification of a contest from pooling the participants' entry fee, executing the smart contract with terms for percentages of earnings rewarded by user type, setting up wallets and terms for cashing out.

In this exemplary embodiment, the system creates a unique token with the name of “SPX” on Binance™. This unique token functions like a unit of currency that gives each contest user access to certain features given by the API “screenplayerx.com”. After a successful initial coin offering (ICO), the system will then integrate the API to get the current rate from trading and the same currency rate will be used for all transactions on screenplayerx.com.

In an embodiment, users may purchase tokens with pre-existing cryptocurrencies (Bitcoin, Ethereum, etc.). This means that a system user will need to already have a cryptocurrency wallet set up with this currency, as well as having a wallet capable of holding SPX currency.

In step 710, the creator submits a contest idea to the system administrator, and it is approved with the launching of a contest, and pays a buy-in fee of $100. In optional step 720, a host joins the creator in the contest with a contract to own all intellectual property of the winning scripts, and pays the buy-in fee.

In step 730, five hundred participants enter the contest by the deadline; and executed a smart contract, and uploading their writing submissions. Each participant pays a buy-in fee of $100 to create a Contest Pool or Genesis Pool. In another embodiment, the system can set a maximum or cap amount of SPX crypto currency to buy, and limit the number of participants who can enter, versus by a deadline date.

The participants, creator, and host may pay with fiat currency (e.g. PayPal™), or with cryptocurrency (e.g. from Ethereum™ and Binance™). This revenue is added to the “Contest Pool” along with revenue from the movie release, and then distributed to the users at either: 1) a set time (e.g. 2 years); or, 2) when a set percentage of investment in the Contest Pool is reached (e.g. 200%), whichever comes first in accordance with the terms of the Smart Contract.

In step 740, the system converts the cash buy-ins to cryptocurrency: e.g. 2,000 SPX's per user (rate of 5 cents per 1 SPX) for a total buy-in of 1 million SPX deposited in the Contest Pool.

In step 750, records are created with timestamps on the blockchain contest file 152 and/or the database records 114 comprising the terms of payment owed to each type of user over the course of the screenplay's and movie's revenue stream. Each user is contracted for a specific amount or percentage of the contest pool, and revenue stream.

Exemplary percentages of payments due by user type are displayed in FIG. 7, in which the terms: Each user earns a predetermined annual percentage yield on the cryptocurrency that is staked in the project. For example, the participant may earn 5% on 1,000 SPX tokens, which would give them an annual percentage yield of 50 SPX tokens per year.

Cashing-Out: in step 760, the Contest Pool or “Genesis Wallet” is maintained for a set period of years (e.g. 2 years) or until a set amount of increase over the original pool is reached (i.e. the Capped Revenue, such as 200%-500% return on original contest pool). When either of these conditions is meet, then tokens will automatically transfer to a user's wallet on their blockchain account, and they will be able to cash-out (e.g. convert SPX tokens to fiat currency that can be converted to cash or deposit in the bank).

### User Electronic Computing Device

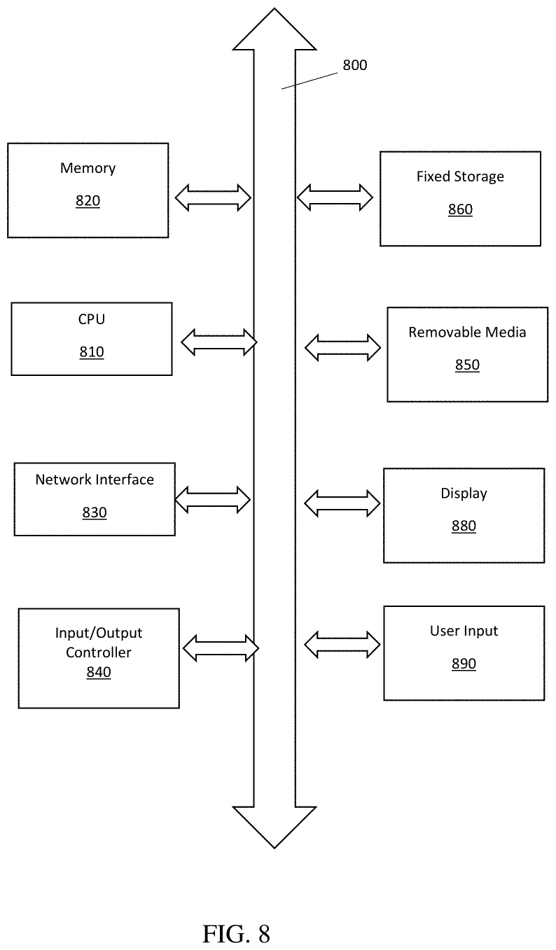

FIG. 8 is a block diagram of the primary components of all computers used in FIG. 1, e.g. the blockchain platform 150, the system server 110, the user electronic computing devices (e.g. FIG. 1, 100-170) comprising a laptop, desktop, tablet or smartphone to access via the internet the user's system database account 114; and their blockchain account 152.

As illustrated in FIG. 8, the computer's comprise an internal bus 800 connecting the major components of each device to its central processing unit (i.e. processor or microprocessor) 810 and memory 820. These computing devices have the ability to transmit and receive electronic communications via a network interface 830 which allows the devices and servers to communicate with each other via one or more local, wide-area, or other networks (FIG. 1, 160).

Memory 820 comprises read-only memory (ROM) or flash memory containing Basic Input-Output system (BIOS) controlling basic hardware operation including interaction with peripheral components. Memory 220 further comprises random access memory (RAM) comprising the main memory into which the device's operating system (e.g. Android or Windows or Apple), and application programs (e.g. blockchain mobile apps) are loaded. The application programs can be stored on and accessed via a non-transitory computer readable storage media, such as a hard disk drive (e.g., fixed storage 860), an optical drive, floppy disk, or other storage medium.

Bus 800 further connects an input/output controller 840, a user display 880, such as a GUI, a user input interface 890, which may include one or more controllers and associated user input devices such as a keyboard, mouse, touchscreen and the like.

Bus 800 further connects the fixed storage 860 (such as a hard drive, flash storage, Fiber Channel network, SAN device, SCSI device, and the like); and a removable media component 850 that is operative to control and receive an optical disk, flash drive, memory card, and the like. The fixed storage 860 may be integral with the other user devices or it may be separate and accessed through other interfaces. Computer program code to implement the various embodiments can be stored as non-transitory computer-readable storage media, such as one or more of the memory 820, fixed storage 860, removable media 850, or on a remote storage location.

The user input interface 890 enables a user to enter data and/or instructions to the electronic computing devices through one or more corresponding input devices, such as an image scanner w/camera, a touch screen, a keyboard, a mouse, a trackball, a light pen, stylus, or other pointing device, a microphone, a joystick, a game pad, a satellite dish, a scanner, a camcorder, a digital camera, and the like. Similarly, examples of input interfaces 890 that may be used to connect the input devices to the bus 800 include a serial port, a parallel port, a game port, a universal serial bus (“USB”), a firewire (IEEE 1394), or another interface. Lastly, output interfaces connect one or more corresponding output devices to the bus 800, such as a monitor or display screen 880, a speaker, a printer, and the like. An output device can integrated with or peripheral to device, such as a video adapter, an audio adapter, a parallel port, and the like.

### Conclusion

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The trademarks disclosed in the present invention are the property of their registered owners.

What is claimed is:

1. A networked computerized system for crowdsourced, blockchain screenplay writing contests, comprising:
a) a plurality of user computers for creating a screenplay writing contest, and for submitting in response to the contest, one or more writing submissions comprising: a screenplay logline, an outline, a draft, and/or a re-write for a plurality of screenplay contests;
b) a local or a remote server comprising: a central processing unit; a memory; and a database storing a file for each of the plurality of screenplay contests;
c) a blockchain server for recording and tracking all transactions in a blockchain account associated with each screenplay contest;
d) an administrator computer for concurrently monitoring and controlling the screenplay contests, the remote server, and the blockchain server;
e) a network for linking (a-e);
f) wherein all transactions for each user in the plurality of screenplay contests is date and timestamped and securely stored on both the database file and the blockchain account; and
g) wherein the plurality of user computers comprise: a creator, host, or administrator computer for posting a screenplay writing contest; a plurality of participant computers for submitting a response to the contest; and at least one analyst computer for analyzing and mining the writing submissions.

2. The networked computerized system of claim 1, further comprising a Smart Contract executed by the user for each of the plurality of screenplay contests the user enters, with terms comprising:
a) a buy-in fee for the user to participate in each screenplay contest;
b) an amount or percentage of revenue the user will earn if the user's screenplay wins the contest or is considered to contribute to it;
c) an amount or percentage of revenue the user will earn if the screenplay is sold;
d) an amount or percentage of revenue the user will earn if a movie generates gross earnings;
e) one or more conditions for when a user may cash-out their earnings; and
f) a guarantee the winning and/or contributing screenplay writer will receive movie credits.

3. The networked computerized system of claim 2, wherein the plurality of user buy-in fees and earned revenue, for each of the plurality of screenplay contests, are stored in a contest pooled account as blockchain tokens, and saved until the cash-out conditions are met.

4. The networked computerized system of claim 2, wherein the user is a contest participant who is submitting a screenplay logline, outline, draft, and/or re-write, and the Smart Contract further comprises terms for the contest participant to transfer ownership of their submission to a host or creator in consideration for receiving a share of (a-d).

5. The networked computerized system of claim 1, wherein the system awards the users one or percentages of: a contest pool; annual percentage yield; a screenplay revenue; a movie revenue; and a producer's backend net revenue.

6. The networked computerized system of claim 1, further comprising a blockchain wallet for each user, storing a plurality of tokens earned by the user in one or more screenplay contests the user has entered, wherein the tokens are able to be converted to cash when a contest's buy-out conditions are met.

7. The networked computerized system of claim 6, wherein the buy-out conditions comprise:
a) a set period of time has passed since a screenwriter winner was declared, or from a contest start date; or
b) until a set amount of increase over an original pool account balance is reached; or
c) whichever occurs first (a or b).

8. The networked computerized system of claim 1, wherein the user computer comprises at least one analyst computer comprising non-transitory computer readable storage medium encoding computer instructions to enable the analyst to grade and mine each of the plurality of writing submissions submitted in a contest using a content scoring algorithm.

9. The networked computerized system of claim 8, wherein the content scoring algorithm requires the analyst to input a response to a series of weighted questions about each writing submission.

10. The networked computerized system of claim 8, wherein the mining comprises the analyst to identify one or more character and/or plot features within the writing submissions, wherein a user becomes a contributor if their character and/or feature is amended into another user's winning screenplay.

11. The networked computerized system of claim 8, wherein the analyst is awarded by the system a percentage of the contest pool.

12. The networked computerized system of claim 8, wherein one of the plurality of user computers is a creator computer for posting a contest on the system; and another is a host computer for inputting the winning screenplay based in part on the analyst's grade.

13. The networked computerized system of claim 1, wherein the user is a participant who enters multiple screenplay contests at one time; and/or who re-enters the same contest to re-write or add to another user's submission.

14. The networked computerized system of claim 1, wherein the plurality of participant computers and/or an administrator/host computers are able to display: a date of writing submission; a participant name; a contest name; a copy and a grading analysis of each writing submission; one or more winners and contributors for each contest; and, the amount of revenue each user is owed by the system.

15. The networked computerized system of claim 1, wherein a plurality of user computers further comprises an investor computer able to display all submitted screenplays on a Screenplay Initial Coin Offering (ICO) or a data management system and all relevant grading data associated with each screenplay that was generated during the contest.

16. A computer-implemented method for crowdsourcing and using a blockchain to conduct a plurality of screenwriting contests online, comprising:
providing a networked computer system comprising:
a) a plurality of user computers for submitting screenplays, and loglines, outlines, drafts, and/or re-writes for a plurality of screenplay contests,
wherein a user computer comprises: a creator computer for contributing an original concept, which will be the basis for the screenplay writing contest; and a plurality of participant computers for submitting a response to the contest;
b) a remote server comprising: a central processing unit; a memory; and a database storing a file for each of the plurality of screenplay contests;
c) a blockchain server for recording and tracking all transactions associated with each screenplay contest;
d) an administrator or host computer for concurrently monitoring and controlling the screenplay contests, the remote server, and the blockchain server;
e) a network for linking (a-d);
receiving from a creator computer a request to open a screenplay contest, wherein the admin computer generates an online screenwriting contest;
receiving from a plurality of participant computers, a buy-in fee that is stored in a pooled account, and a digital signature to a Smart Contract with terms for entering the contest;
receiving from each of the plurality of participant computers an uploaded screenplay contest entry comprising one or more of: a logline, an outline, a draft, a re-write, or a complete screenplay;
automatedly grading the plurality of screenplay contest entries; and declaring one or more winners, contributors, or continuing the contest by requesting re-writes and new entries;
marketing a winning screenplay for production to a movie; and
wherein all transactions for each user in the plurality of screenplay contests is date and timestamped and securely stored on both the database file and the blockchain account.

17. The computer-implemented method of claim 16, wherein the Smart Contract term comprises one or more of:
a) a buy-in fee for the user to participate in each screenplay contest;
b) an amount or percentage of revenue the user will earn if the user's screenplay wins the contest or is considered to contribute;
c) an amount or percentage of revenue the user will earn if the screenplay is sold;
d) an amount or percentage of revenue the user will earn if a movie generates gross earnings; and
e) one or more conditions for when a user may cash-out their earnings.

18. The computer-implemented method of claim 17, wherein the plurality of user buy-in fees and earned revenue from a sold screenplay and movie are stored in a pooled account as blockchain tokens, and saved until the cash-out conditions are met.

19. The computer-implemented method of claim 17, wherein the user is a contest participant who is submitting a screenplay logline, outline, draft, and/or re-write, and the Smart Contract further comprises terms for the contest participant to transfer ownership of their submission to a host in consideration for receiving a share of one or more of (a-d).

20. The computer-implemented method of claim 16, the networked computer system further comprising a blockchain wallet for each user, storing a plurality of tokens earned by the user in one or more screenplay contests the user has entered, wherein the tokens are able to be converted to cash when a contest's buy-out conditions are met comprising:
a) a set period of time has passed since a screenwriter winner was declared, or from a contest start date; or
b) until a set amount of increase over an original pool account balance is reached; or
c) whichever occurs first (a or b).
